(19) United States
(12) Patent Application Publication
(10) Pub. No.: US 2012/0284498 A1
(43) Pub. Date: Nov. 8, 2012

(54) FLASH DEVICE AND ASSOCIATED BOOTING METHOD

(75) Inventor: Cheng-Yen Chou, New Taipei City (TW)

(73) Assignee: ASMedia Technology Inc., New Taipei City (TW)

(21) Appl. No.: 13/463,114

(22) Filed: May 3, 2012

(30) Foreign Application Priority Data
May 6, 2011 (TW) 100116045

(51) Int. Cl. G06F 15/177

(52) U.S. Cl. 713/2

(57) ABSTRACT

A flash device and a booting method thereof are provided. The booting method includes following steps: executing a basic boot program stored in a read only memory (ROM) of a flash memory micro-controller; reading a specific flash memory configuration parameter and a revision program from a flash memory; loading a main program stored in the flash memory; and executing the revision program and loading the main program stored in the flash memory when the main program fails to be loaded.

### CROSE-REFERENCE TO RELATED APPLICATION

This application claims the priority benefit of Taiwan application serial no. 100116045, filed on May 6, 2011. The entirety of the above-mentioned patent application is hereby incorporated by reference herein and made a part of specification.

### BACKGROUND OF THE INVENTION

1. Field of the Invention

The invention relates to a flash device and a control method and, more particularly, to a flash device and a booting method.

2. Description of the Related Art

A flash device including a flash memory is widely used in various electronic products. The flash device includes a flash memory micro-controller and a flash memory.

FIG. 1 is a schematic diagram showing a conventional flash device. The flash device 100 includes a flash memory micro-controller 110 and a flash memory 120. The flash device 100 is connected to an external host (not shown) and accesses data stored in the flash memory 120 according to commands from the external host.

When the flash device 100 is power on, the flash memory micro-controller 110 executes a booting procedure first. After the booting procedure is finished, the flash device 100 receives the commands from the external host (not shown) and accesses the data from the flash memory 120.

Manufacturers usually buy the flash memory micro-controller 110 and the flash memory 120, respectively, and assemble them together as the flash device 100 with various functions. The flash memory micro-controller 110 initializes various flash memories 120 according to a basic boot program stored in a read only memory (ROM) 114.

With the process technology of flash memory progress continually, the process of the flash memory develops from 50 nm to 20 nm. After a flash memory made, some unpredictable factors may occurred on the flash memory and make the flash device fail to finish the booting procedure.

Consequently, the manufacturers need to add settings to the basic boot program to help the flash device to finish the booting procedure. However, the basic boot program is stored in the ROM 114 which cannot be changed easily. Thus, after the new process flash memory 120 is made and new problems are found by serial tests. The conventional manufactures of the flash memory micro-controller 110 need to design a new flash memory micro-controller 110 and a new basic boot program to deal with the problems. That is, the new process flash memory 120 cooperating with the conventional flash memory micro-controller 110 cannot finish booting procedure.

### BRIEF SUMMARY OF THE INVENTION

A booting method of a flash device includes following steps: executing a basic boot program stored in a ROM of a flash memory micro-controller; reading a specific flash memory configuration parameter and a revision program from a flash memory; loading a main program stored in the flash memory and executing the revision program and loading the main program stored in the flash memory when the main program fails to be loaded.

A flash device includes a flash memory micro-controller and a flash memory. The flash memory micro-controller includes a ROM storing a basic boot program. The flash memory is connected to the flash memory micro-controller and includes a data section, a parameter section and a main program section. The main program section stores a main program and the parameter section stores a specific flash memory configuration parameter and a revision program. In a booting procedure of the flash device, after the flash memory micro-controller executes the basic boot program, the flash memory micro-controller reads the specific flash memory configuration parameter and the revision program, and when the main program fails to be loaded, the flash memory micro-controller executes the revision program to load the main program.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a conventional flash device;

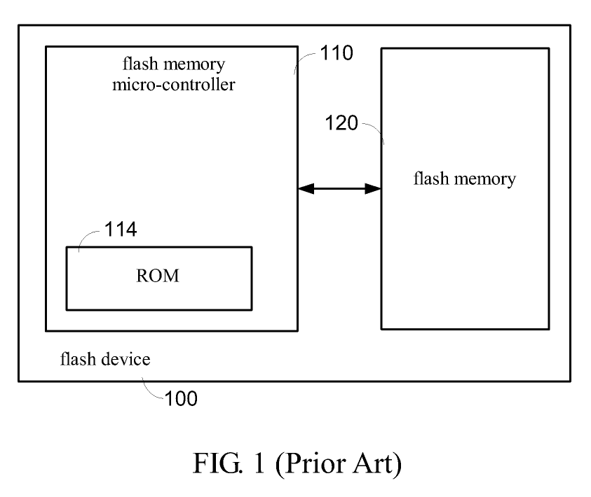

FIG. 2 is a schematic diagram showing a flash device in an embodiment; and

FIG. 3 is a flow chart showing a booting process of a flash device in an embodiment.

### DETAILED DESCRIPTION OF THE EMBODIMENTS

Conventionally, in advanced process flash memory may exist bad column. It means that data in a specific bit of the flash memory cannot be read or have an error. If the problem is not solved in the basic boot program, the flash device cannot finish the booting process.

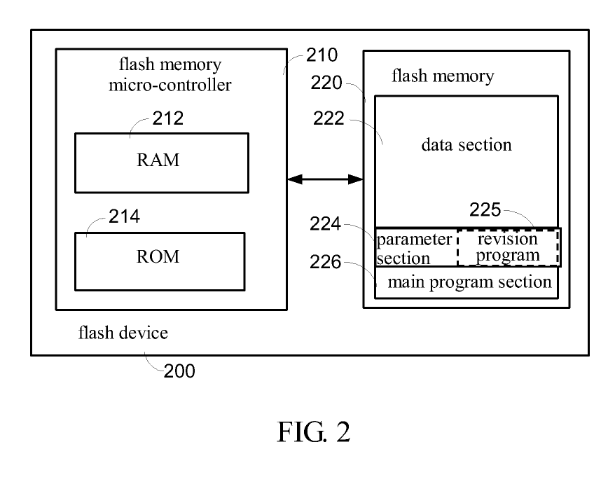

FIG. 2 is a schematic diagram showing a flash device in an embodiment. The flash device 200 includes a flash memory micro-controller 210 and a flash memory 220. The flash memory micro-controller 210 is connected to an external host (not shown) and accesses the data of the flash memory 220 according to commands from the external host.

In an embodiment, a parameter section 224 of the flash memory 220 stores a specific flash memory configuration parameter and a revision program 225. The revision program 225 is used to deal with various problems of the flash memory 220.

The flash memory micro-controller 210 can cooperate with various flash memories 220, and a basic boot program stored in a ROM 214 of the flash memory micro-controller 210 does not need to be revised. Capacity of the parameter section 224 is at least 1K to 4K bytes, capacity of the main program section 226 is approximately 256K to 512K bytes, and capacity of the data section 222 is the largest.

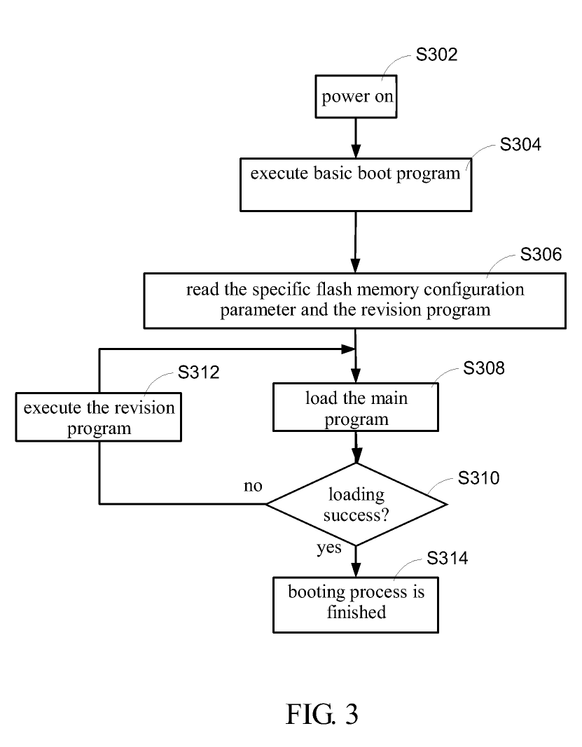

FIG. 3 is a flow chart showing a booting procedure of a flash device in an embodiment. When the flash device 200 is powered on (step S302), the flash device 200 first executes the basic boot program stored in the ROM 214 (step S304) to initialize the flash memory. The basic boot program can be used in various flash memories and t includes a basic flash memory configuration parameter to initialize the flash memory 220. After the basic boot program is executed, the flash memory micro-controller 210 reads the specific flash memory configuration parameter and the revision program 225 from the flash memory 220 (step S306). That is, the flash memory micro-controller 210 first initializes the flash memory 220 according to the basic flash memory configuration parameter, and then reads the specific flash memory configuration parameter and the revision program 225 from the parameter section 224 of the flash memory 220.

The flash memory micro-controller 210 loads a main program according to the specific flash memory configuration parameter (step S308). That is, the main program stored in the main program section 226 is loaded to a random access memory (RAM) 212 of the flash memory micro-controller 210.

After the main program is loaded (step S310), it means that the booting procedure is finished (step S314). The flash memory micro-controller 210 executes the main program and the flash device starts to operate. Contrarily, when the main program fails to be loaded (step S310), the flash memory micro-controller 210 executes the revision program 225 (step S312) to solve the problems of the flash memory 220.

The capacity of the parameter section 224 in the flash memory 220 is usually small and only stores the specific flash memory configuration parameter. In the embodiment, the parameter section 224 stores the revision program 225. When the flash memory micro-controller 210 reads the specific flash memory configuration parameter, it also reads the revision program 225, and when the booting process fails, the revision program is executed to solve the problem of the booting failure.

As stated above, though the process technology of flash memory keeps progress and many unexpected problems of the new flash memory may come up, the revision program can solve the problems which result in the booting failure. In other words, when the flash memory micro-controller 210 reads the specific flash memory configuration parameter from the parameter section 224, it also reads the revision program 225. After the booting failure of the flash device 200 is confirmed, the flash memory micro-controller 210 further executes the revision program 225 to finish the booting procedure successfully.

Consequently, there is no need to revise the basic boot program stored in the ROM 214 of the flash memory micro-controller 210. It needs only to add a revision program to the parameter section 224 of the flash memory 220 to solve the problems of booting failure. Thus, the flash memory micro-controller 210 can cooperate with various new process flash memories 220 and finish the booting successfully.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A booting method of a flash device comprising following steps:
executing a basic boot program stored in a read only memory (ROM) of a flash memory micro-controller;
reading a specific flash memory configuration parameter and a revision program from the flash memory;
loading a main program stored in the flash memory; and
executing the revision program and loading the main program stored in the flash memory when the main program fails to be loaded.

2. The booting method according to claim 1, wherein the flash memory includes a data section, a parameter section and a main program section, the main program section stores the main program, and the parameter section stores the specific flash memory configuration parameter and the revision program.

3. The booting method according to claim 1, wherein the flash memory micro-controller further includes a random access memory (RAM) which loads the main program to make the flash memory micro-controller execute the main program.

4. The booting method according to claim 1, wherein the basic boot program includes a basic flash memory configuration parameter used to initialize the flash memory.

5. The booting method according to claim 1, wherein the flash memory micro-controller reads the main program according to the specific flash memory configuration parameter.

6. A flash device, comprising:
a flash memory micro-controller including a ROM storing a basic boot program; and
a flash memory connected to the flash memory micro-controller, wherein the flash memory includes a data section, a parameter section and a main program section, the main program section stores a main program, and the parameter section stores a specific flash memory configuration parameter and a revision program;
wherein in a booting process of the flash device, after the flash memory micro-controller executes the basic boot program, the flash memory micro-controller reads the specific flash memory configuration parameter and the revision program, and when the main program fails to be loaded, the flash memory micro-controller executes the revision program to load the main program.

7. The flash device according to claim 6, wherein the flash device further includes a random access memory (RAM), and the main program is loaded to the RAM.

8. The flash device according to claim 6, wherein the basic boot program includes a basic flash memory configuration parameter to initialize the flash memory.

9. The flash device according to claim 6, wherein the flash memory micro-controller reads the main program according to the specific flash memory configuration parameter.
